(19) United States
(12) Patent Application Publication
(10) Pub. No.: US 2025/0077614 A1
(43) Pub. Date: Mar. 6, 2025

(54) FFT PROCESSOR OF R4MDC STRUCTURE WITH INTEGRATED DOUBLE BUFFER AND OPERATING METHOD THEREOF

(71) Applicant: University of seoul Industry Cooperation Foundation, Seoul (KR)

(72) Inventors: Kichul KIM, Seoul (KR); Giseon LEE, Anyang-si (KR); Jungi PARK, Seoul (KR)

(73) Assignee: University of seoul Industry Cooperation Foundation, Seoul (KR)

(21) Appl. No.: 18/821,720

(22) Filed: Aug. 30, 2024

(30) Foreign Application Priority Data
Aug. 30, 2023 (KR) 10-2023-0114974

(51) Int. Cl. G06F 17/14

(52) U.S. Cl. CPC G06F 17/142

(57) ABSTRACT

The FFT processor having an N-point Radix-4 multi-path delay commutator (R4MDC) structure having a power of 4 comprises: a first memory bank; and second to fourth memory banks configured to delay an output of data.

### CROSS-REFERENCE TO RELATED APPLICATIONS

This application claims the benefit of Korea Patent Application No. 10-2023-0114974, filed on 30 Aug. 2023, which is incorporated herein by reference for all purposes as if fully set forth herein.

### TECHNICAL FIELD

The present disclosure relates to an FFT processor that reduces a memory size and a latency by improving a structure of a double buffer and a delay element for data delay in a pipelined FFT processor using an R4MDC structure.

### BACKGROUND

Generally, a structure of a FFT processor has widely used a pipelined structure. Radix-4 Multi-path Delay Commutator (R4MDC), which is a Multi-path Delay Commutator (MDC) structure based on a radix-4 method, is also widely used as one of pipelined FFTs. The R4MDC has a structure that processes N-point inputs with power of 4. The R4MDC simultaneously receives four inputs and sequentially processes data through a butterfly unit, a memory, and a multiplier that are connected in series. Therefore, the R4MDC is widely used in FFTs requiring high performance because it has a high processing speed.

The pipelined FFT structure needs to simultaneously receive new data while sequentially processing data. Therefore, a method in which a double buffer is arranged at an input end so that data can be processed and a new input can be received is widely used. The double buffer is a buffer in which two buffers operate interchangeably as an input and an output, enabling simultaneously the input and the output and guaranteeing an uninterrupted output from first output data to last output data of a sequence. FIG. 1 illustrates a schematic configuration of R4MDC including a double buffer.

Because the existing R4MDC simultaneously requires four inputs on the input end, an appropriate delay is required for input data. To this end, as illustrated in FIG. 2, the four inputs are simultaneously provided to a FFT operation using a delay element (a commutator 20 and a delay unit 30) in an input unit. However, due to the double buffer 10 and the delay elements 20 and 30, data input is delayed, and a large amount of memory usage is required.

### SUMMARY

The present invention has been devised in the above-described technical background and aims to improve the problem that data input is delayed and a large amount of memory usage is required by integrating a double buffer and a delay element for data delay in R4MDC, which is a pipelined FFT structure.

In order to solve the above technical problems, in one aspect of the present disclosure, there is provided an FFT processor having an N-point Radix-4 multi-path delay commutator (R4MDC) structure having a power of 4, the FFT processor comprising a first memory bank and second to fourth memory banks configured to delay an output of data, wherein the first memory bank includes first to (N/2)th memory blocks, and the first to (N/4)th memory blocks and the (N/4+1)th to (N/2)th memory blocks operate by interchanging write and read, wherein each of the second to fourth memory banks includes (N/4) memory blocks, wherein after data is written to the first to (N/4)th memory blocks or the (N/4+1)th to (N/2)th memory blocks of the first memory bank and all the memory blocks of the second to fourth memory banks, every four data from data x[0] of the first memory block of the first memory bank or the (N/4+1)th memory block of the first memory bank and data x[N/4], x[N/2], and x[3N/4] of first memory blocks of the second to fourth memory banks to data data x[N/4−1] of the (N/4)th memory block of the first memory or the (N/2)th memory block of the first memory bank and data x[N/2−1], x[3N/4−1], and x[N−1] of the last memory blocks of the second to fourth memory banks are sequentially read in parallel to a butterfly of a first stage, and at the same time newly input data is sequentially written to the memory blocks.

While the data x[0] to x[N/4−1] is written and read to the first to (N/4)th memory blocks of the first memory bank, newly input data is sequentially written to the (N/4+1)th to (N/2)th memory blocks. In addition, while the data x[0] to x[N/4−1] is written and read to the (N/4+1)th to (N/2)th memory blocks of the first memory bank, newly input data is sequentially written to the first to (N/4)th memory blocks.

After data is written to the first to (N/4)th memory blocks or the (N/4+1)th to (N/2)th memory blocks of the first memory bank, data is sequentially written to the memory blocks of the second to fourth memory banks. In addition, no read operation is performed until all data of a current sequence is written to all the memory blocks.

Another aspect of the present disclosure also discloses an FFT processor that implements the driving method described above.

An input processing unit according to the present disclosure replaces configuration for a double buffer and a delay according to a related art. Hence, the present disclosure can reduce a latency by removing delay elements (commutator and delay) from the existing R4MDC structure and can reduce a memory size required for the double buffer by half.

### BRIEF DESCRIPTION OF THE DRAWINGS

The accompanying drawings, which are included to provide a further understanding of the present disclosure and constitute a part of the detailed description, illustrate embodiments of the present disclosure and serve to explain technical features of the present disclosure together with the description.

FIG. 1 illustrates a schematic configuration of R4MDC including a double buffer according to a related art.

FIG. 2 illustrates a FFT processor having configuration of N-point R4MDC including a double buffer according to a related art.

FIG. 3 illustrates configuration of an N-point FFT processor integrated with a double buffer according to the present disclosure.

FIGS. 4 to 10 schematically illustrate a series of processes of data processing.

FIG. 11 is a flowchart illustrating a method of driving an FFT processor according to the present disclosure illustrated in FIG. 3.

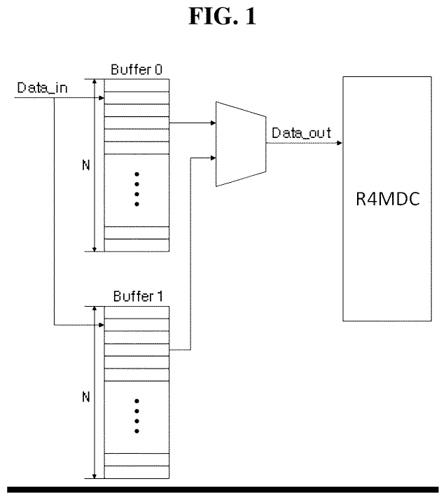

### DETAILED DESCRIPTION

Reference will now be made in detail to embodiments of the disclosure, examples of which are illustrated in the accompanying drawings. Detailed descriptions of known arts will be omitted if such may mislead the gist of the present disclosure. In addition, throughout the present disclosure, “comprising” a certain component means that other components may be further comprised, not that other components are excluded, unless otherwise stated.

Further, although the terms first, second, etc. may be used herein to describe various components, these components should not be limited by these terms. These terms are only used to distinguish one component from another component. For example, a first component may be referred to as a second component, and, similarly, a second component may be referred to as a first component, without departing from the scope of the present disclosure.

Terms used in the present disclosure are only used to describe specific embodiments, and are not intended to limit the present disclosure. Expressions in the singular form include the meaning of the plural form unless they clearly mean otherwise in the context. In the present disclosure, expressions such as “comprise” or “have” are intended to mean that the described features, numbers, steps, operations, components, parts, or combinations thereof exist, and should not be understood to be intended to exclude in advance the presence or possibility of addition of one or more other features, numbers, steps, operations, components, parts, or combinations thereof.

Unless otherwise specified, all of the terms which are used herein, including the technical or scientific terms, have the same meanings as those that are generally understood by a person having ordinary skill in the art to which the present disclosure pertains. The terms defined in a generally used dictionary can be understood to have meanings identical to those used in the context of a related art, and are not to be construed to have ideal or excessively formal meanings unless they are obviously specified in the present disclosure.

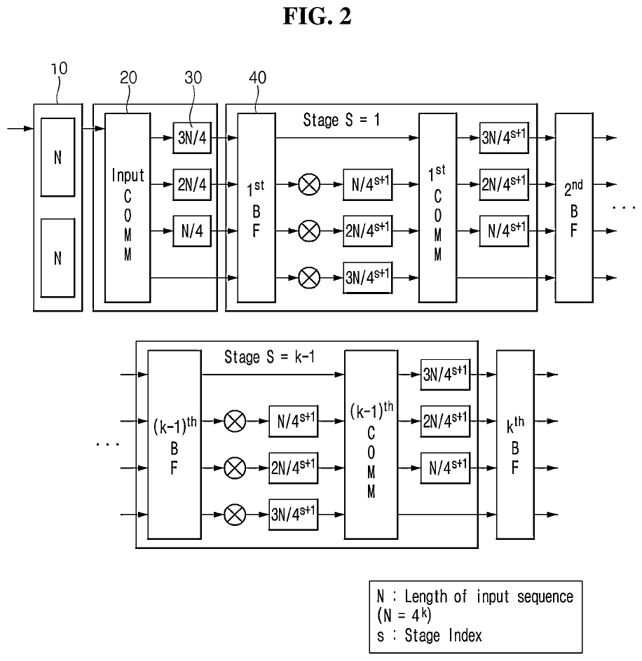

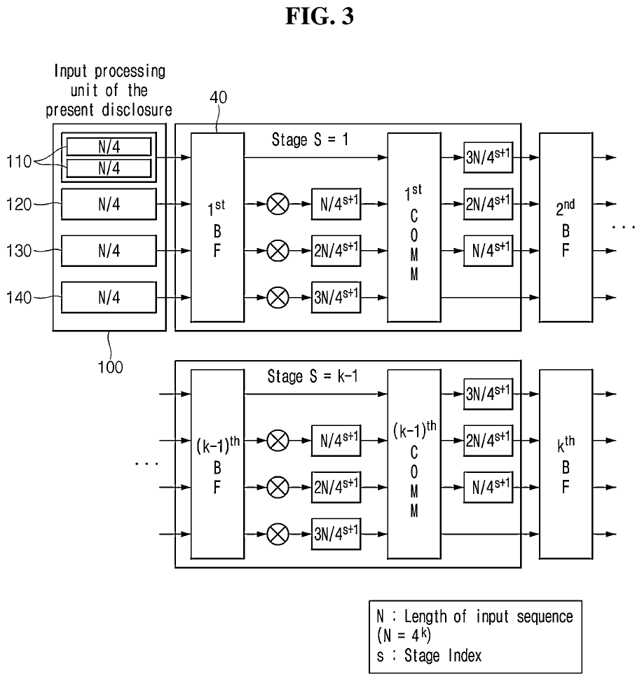

FIG. 2 illustrates a FFT processor having configuration of N-point R4MDC including a double buffer according to a related art. FIG. 3 illustrates configuration of an N-point FFT processor integrated with a double buffer according to the present disclosure.

A FFT processor according to the present disclosure is described below in comparison with the related art.

First, the FFT processor according to the related art illustrated in FIG. 2 has a structure in which a double buffer 10, a commutator 20, a delay unit 30, and a butterfly unit 40 are sequentially arranged from an input end.

The commutator 20 and the delay unit 30 included in a first stage delay an input of data and allow data to be processed in parallel.

On the other hand, the FFT processor according to the present disclosure includes an input processing unit 100 in which a double buffer 10, a commutator 20, and a delay unit 30 with the conventional configuration are integrated into one memory.

The FFT processor according to the present disclosure is different from the FFT processor according to the related art in that data delayed and read in parallel by the input processing unit 100 is configured to be input to a butterfly unit 40.

The present disclosure reduces an input delay and memory size by integrating the double buffer 10, the commutator 20, and the delay unit 30 according to the related art into one memory.

The input processing unit 100 of the FFT processor according to the present disclosure illustrated in FIG. 3 includes a first memory bank 110 and second to fourth memory banks 120, 130, and 140 that delay an output of data. The first memory bank 110 includes first to (N/2)th memory blocks MB, and first to (N/4)th memory blocks and (N/4+1)th to (N/2)th memory blocks operate by interchanging writes and reads to serve as a double buffer. Each of the second to fourth memory banks includes (N/4) memory blocks.

An operation of the FFT processor according to the present disclosure is described in detail below.

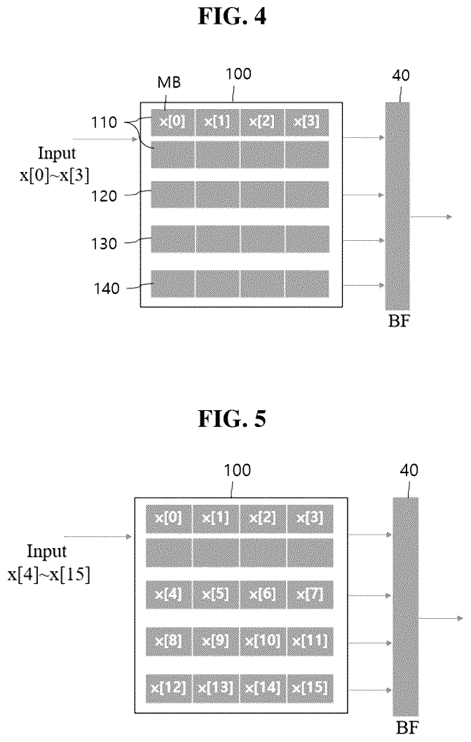

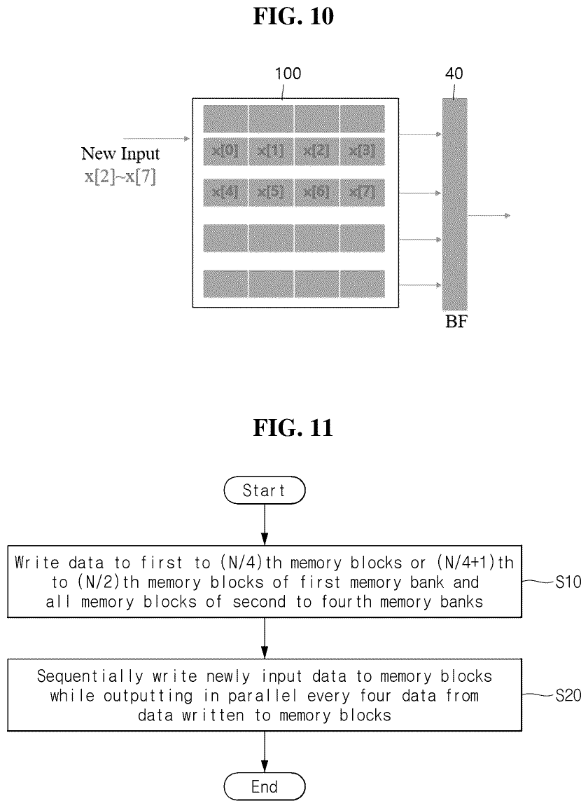

FIGS. 4 to 10 illustrate a series of processes in which data is processed in the input processing unit 100 using 16 points as an example. FIGS. 4 to 10 illustrate merely an example of 16 points for convenience of explanation. The present disclosure is not limited to a 16-point FFT, and is a technology applicable to all of N-point FFTs having a power of 4.

A driving method according to the present disclosure includes a step S10 of writing data to first to (N/4)th memory blocks or (N/4+1)th to (N/2)th memory blocks of a first memory bank and all memory blocks of second to fourth memory banks; and a step S20 of sequentially reading in parallel every four data from data of the first memory block or data x[0] of the (N/4+1)th memory block of the first memory bank and data x[N/4], x[N/2], and x[3N/4] of first memory blocks of the second to fourth memory banks to data of the (N/4)th memory block or data x[N/4−1] of the (N/2)th memory block of the first memory bank and data x[N/2−1], x[3N/4−1], and x[N−1] of the first memory blocks of the second to fourth memory banks to a butterfly of the first stage and at the same time sequentially writing newly input data to the memory blocks.

In this instance, while data x[0] to x[N/4−1] is written and read to the first to (N/4)th memory blocks of the first memory bank, newly input data is sequentially written to the (N/4+1)th to (N/2)th memory blocks.

Further, while data x[0] to x[N/4−1] is written and read to the (N/4+1)th to (N/2)th memory blocks of the first memory bank, newly input data is sequentially written to the first to (N/4)th memory blocks.

Further, after data is written to the first to (N/4)th memory blocks or the (N/4+1)th to (N/2)th memory blocks of the first memory bank, data is sequentially written to the memory blocks of the second to fourth memory banks.

In addition, no read operation is performed until all data of a current sequence is written to all the memory blocks.

The driving method according to the present disclosure is described below using an example implemented in a 16-point FFT processor as an embodiment, but is not limited thereto.

As illustrated in FIG. 4, 1st data x[0] is written to a first memory block of the first memory bank 110 in response to a clock signal. Further, 2nd data x[1], 3rd data x[2], and 4th data x[3] that are sequentially input are written to a second memory block, a third memory block, and a fourth memory block of the first memory bank 110, respectively.

When one line is filled with data in the first memory bank 110 serving as the double buffer, data x[4] to x[15] sequentially input as illustrated in FIG. 5 is then sequentially written one line at a time to the second to fourth memory banks 120, 130, and 140 serving as the delay.

In response to a next clock signal, 5th data x[4] to 8th data x[7] are sequentially written to a memory block of the second memory bank 120, 9th data x[8] to 12th data x[11] are sequentially written to a memory block of the third memory bank 130, and 13th data x[12] to 16th data x[15] are sequentially written to the fourth memory bank 140.

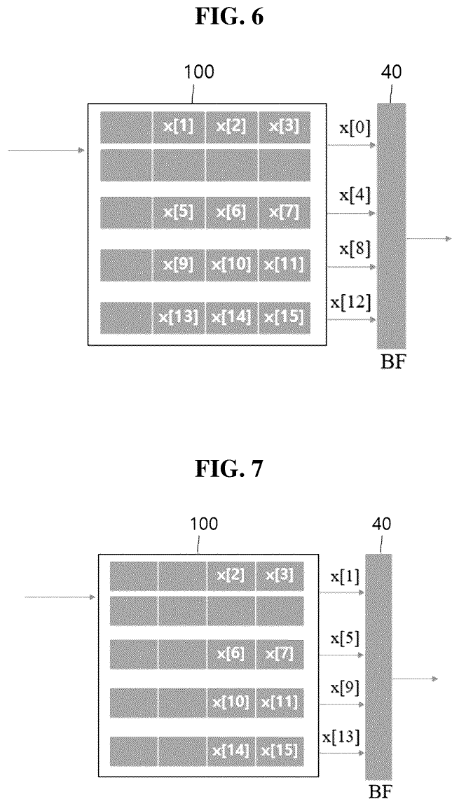

After data is sequentially stored in the memory blocks of all the memory banks as above, as illustrated in FIG. 6, 1st data x[0] written for the first time to the first memory bank, 5th data x[4] written for the 5th time to the second memory bank, 9th data x[8] written for the 9th time to the third memory bank, and 13th data x[12] written for the 13th time to the fourth memory bank, which are stored in a first row of each memory bank, are read in parallel to the butterfly unit 40 of the first stage.

In the next clock signal, as illustrated sequentially in FIGS. 7 to 9 in the same manner as the previous clock signal, 2nd data x[1], 6th data x[5], 10th data x[9], and 14th data x[13] which have been stored in a second row of each memory bank are output, 3rd data x[2], 7th data x[6], 11th data x[10], and 15th data x[14] which have been stored in a third row of each memory bank are output, and 4th data x[3], 8th data x[7], 12th data x[11], and 16th data x[15] which have been stored in a fourth row of each memory bank are output.

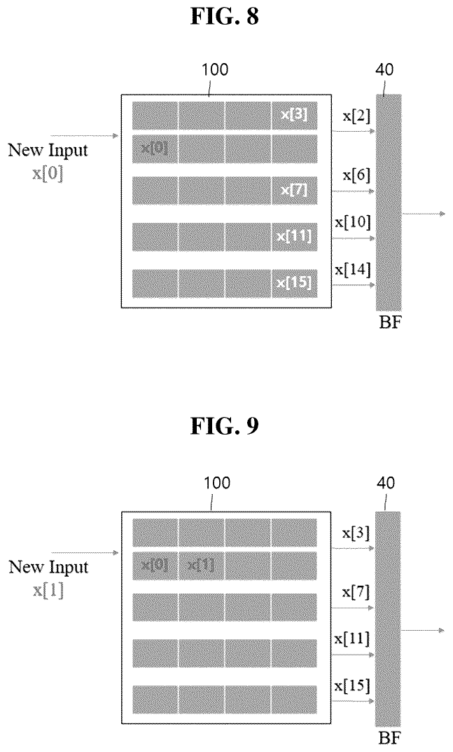

While data is being output as above, if new data is input to the input processing unit 100 as illustrated in FIGS. 8 to 10, the newly input data is sequentially written to an write operation memory block of the first memory bank, and data input thereafter is sequentially input to the second to fourth memory banks.

The latency and memory size of the present disclosure compared to the related art are as shown in Table 1 below.

TABLE 1

| | Present Disclosure | Related Art |
|---|---|---|
| Memory Size | 5N/4 | 7N/2 |
| Latency | N Clk | 7N/4 Clk |

Clk in the latency denotes a system clock, and the size of the memory indicates the number of memory blocks that store data.

The above results are calculated as follows.

When generalized as an N-point FFT, it takes time of N clocks (Clk) until all data is stored in the double buffer in the configuration according to the related art, and it takes time of 3N/4 clocks (Clk) until a parallel input is formed. Therefore, the latency required to start the operation is 7N/4 clocks (Clk). Here, the latency refers to a time taken from when first data is input until the input enters the butterfly of the first stage.

Further, the amount of memory required (the number of double buffers and delays) is (N+N)+(3N/4+N/2+N/4)=7N/2. Here, (N+N) is the number of memories of the double buffer, and (3N/4+N/2+N/4) is the number of memories of the delay.

On the other hand, in the present disclosure, the time required until all data is stored in the input processing unit 100 is N clocks (Clk), and 0 clock (Clk) is required to form a parallel input. Therefore, the latency is N clocks (Clk). Further, the amount of memory required is 5N/4+0=5N/4. Here, 5N/4 is the number of memories of the input processing unit, and 0 is the number of memories of the removed delay.

As described above, the configuration of the FFT processor according to the present disclosure can drastically reduce the memory size and the latency compared to the related art.

In the above description, the first memory bank has been described as an example of including different input/output memory blocks, but the first memory bank may also be configured as a dual port RAM having both input/output ports.

As described above, the present disclosure has been examined focusing on its various embodiments. A person with ordinary skills in the technical field to which the present disclosure pertains will be able to understand that the various embodiments can be implemented in modified forms within the scope of the essential characteristics of the present disclosure. Therefore, the disclosed embodiments are to be considered illustrative rather than restrictive. The scope of the present disclosure is shown in the claims rather than the foregoing description, and all differences within the scope should be construed as being included in the present disclosure.

What is claimed is:

1. An FFT processor having an N-point Radix-4 multi-path delay commutator (R4MDC) structure having a power of 4, the FFT processor comprising:
a first memory bank; and
second to fourth memory banks configured to delay an output of data,
wherein the first memory bank includes first to (N/2)th memory blocks, and the first to (N/4)th memory blocks and the (N/4+1)th to (N/2)th memory blocks operate by interchanging write and read,
wherein each of the second to fourth memory banks includes (N/4) memory blocks,
wherein after data is written to the first to (N/4)th memory blocks or the (N/4+1)th to (N/2)th memory blocks of the first memory bank and all the memory blocks of the second to fourth memory banks, every four data from data x[0] of the first memory block of the first memory bank or the (N/4+1)th memory block of the first memory bank and data x[N/4], x[N/2], and x[3N/4] of first memory blocks of the second to fourth memory banks to data data x[N/4−1] of the (N/4)th memory block of the first memory or the (N/2)th memory block of the first memory bank and data x[N/2−1], x[3N/4−1], and x[N−1] of the last memory blocks of the second to fourth memory banks are sequentially read in parallel to a butterfly of a first stage, and at the same time newly input data is sequentially written to the memory blocks.

2. The FFT processor of claim 1, wherein while the data x[0] to x[N/4−1] is written and read to the first to (N/4)th memory blocks of the first memory bank, newly input data is sequentially written to the (N/4+1)th to (N/2)th memory blocks.

3. The FFT processor of claim 2, wherein while the data x[0] to x[N/4−1] is written and read to the (N/4+1)th to (N/2)th memory blocks of the first memory bank, newly input data is sequentially written to the first to (N/4)th memory blocks.

4. The FFT processor of claim 2, wherein after data is written to the first to (N/4)th memory blocks or the (N/4+1)th to (N/2)th memory blocks of the first memory bank, data is sequentially written to the memory blocks of the second to fourth memory banks.

5. The FFT processor of claim 3, wherein after data is written to the first to (N/4)th memory blocks or the (N/4+1)th to (N/2)th memory blocks of the first memory bank, data is sequentially written to the memory blocks of the second to fourth memory banks.

6. The FFT processor of claim 4, wherein no read operation is performed until all data of a current sequence is written to all the memory blocks.

7. The FFT processor of claim 5, wherein no read operation is performed until all data of a current sequence is written to all the memory blocks.

8. A driving method of an FFT processor having an N-point Radix-4 multi-path delay commutator (R4MDC) structure having a power of 4, the FFT processor including a first memory bank and second to fourth memory banks configured to delay an output of data, the first memory bank including first to (N/2)th memory blocks, wherein the first to (N/4)th memory blocks and the (N/4+1)th to (N/2)th memory blocks operate by interchanging writes and reads, each of the second to fourth memory banks including (N/4) memory blocks, the driving method comprising:
writing data to the first to (N/4)th memory blocks or the (N/4+1)th to (N/2)th memory blocks of the first memory bank and all the memory blocks of the second to fourth memory banks; and sequentially reading in parallel every four data from data x[0] of the first memory block of the first memory bank or the (N/4+1)th memory block of the first memory bank and data x[N/4], x[N/2], and x[3N/4] of first memory blocks of the second to fourth memory banks to data x[N/4−1] of the (N/4)th memory block of the first memory bank or the (N/2)th memory block of the first memory bank and data x[N/2−1], x[3N/4−1], and x[N−1] of the last memory blocks of the second to fourth memory banks to a butterfly of a first stage, and at the same time sequentially writing newly input data to the memory blocks.

9. The driving method of claim 8, wherein while the data x[0] to x[N/4−1] is written and read to the first to (N/4)th memory blocks of the first memory bank, newly input data is sequentially written to the (N/4+1)th to (N/2)th memory blocks.

10. The driving method of claim 8, wherein while the data x[0] to x[N/4−1] is written and read to the (N/4+1)th to (N/2)th memory blocks of the first memory bank, newly input data is sequentially written to the first to (N/4)th memory blocks.

11. The driving method of claim 9, wherein after data is written to the first to (N/4)th memory blocks or the (N/4+1)th to (N/2)th memory blocks of the first memory bank, data is sequentially written to the memory blocks of the second to fourth memory banks.

12. The driving method of claim 10, wherein after data is written to the first to (N/4)th memory blocks or the (N/4+1)th to (N/2)th memory blocks of the first memory bank, data is sequentially written to the memory blocks of the second to fourth memory banks.

13. The driving method of claim 11, wherein no newly input data is output until all data of a current sequence is written to all the memory blocks.

14. The driving method of claim 12, wherein no newly input data is output until all data of a current sequence is written to all the memory blocks.
